(19) United States
(12) Patent Application Publication
(10) Pub. No.: US 2022/0185035 A1
(43) Pub. Date: Jun. 16, 2022

(54) TIRE WITH IMPROVED BEAD STRUCTURE

(71) Applicant: The Goodyear Tire & Rubber Company, Akron, OH (US)

(72) Inventors: Kiyoshi Ueyoko, Copley, OH (US); Badal Das, Strongsville, OH (US)

(21) Appl. No.: 17/123,215

(22) Filed: Dec. 16, 2020

(51) Int. Cl. B60C 15/06

(52) U.S. Cl. CPC B60C 15/0632

(57) ABSTRACT

A pneumatic radial tire having a bead portion provided therein with a bead core, wherein the bead core is wrapped with a flipper, wherein the flipper is formed of a reinforced material, wherein the flipper has an axially inner leg that extends radially outward to a radial distance Li from the reference line XX′, wherein the line XX′ extends through the geometric center of the bead core, wherein the radial distance Li is equal to or greater than the bead radius, as measured in a radial direction from line XX′.

### FIELD OF THE INVENTION

The invention relates in general to pneumatic tires, and more particularly to a bead construction for heavy duty vehicles such as aircraft or trucks.

### BACKGROUND OF THE INVENTION

Annular tensile members, commonly referred to as tire bead cores, are designed to securely hold the tire on the rim during use. The tire beads provide a radially inner portion between the bead core and the rim that is radially compressed, and as this portion is compressed, the bead core is placed in tension. Radial compression occurs as the tire is mounted on a tapered rim seat by the action of the internal pressure of the tire pushing the bead axially outwardly toward the vertical bead flange.

Recently, attempts have been made to provide a heavy duty bead construction that has a reduced weight. One approach has been to use the combination of steel wire and aramid core. The primary issue with synthetic cords is that when provided in a cable that has the cords twisted, several problems are created. The first is called creep under load. The synthetic cables or cords will stretch under load and as the plastic flows, the restraining force actually will lower with time, accordingly the use of steel in a radially innermost layer is essential if bead retention forces are to be reliably constant. A second problem is fretting, Aramid, in particular, and many other plastics have a condition where small brittle fractures occur if the cords are placed in compression. Cabling such cords actually increase the likelihood of creating these fractures. In a bead core, almost all of the loads are in tension except when the bead is helically or spirally wound. In those cases, the cords work against each other creating small bending forces, which over time result in minute abrading friction of the adjacent cords, resulting in fretting.

Thus, an improved bead design which is light weight without sacrificing strength is desired, and that further overcomes the disadvantages mentioned above.

### SUMMARY OF THE INVENTION

The invention provides in a first aspect a pneumatic radial tire having a bead portion provided therein with a bead core, wherein the bead core is wrapped with a flipper, wherein the flipper is formed of a reinforced material, wherein the flipper has an axially inner leg that extends radially outward to a radial distance Li from the reference line XX′, wherein the line XX′ extends through the geometric center of the bead core, wherein the radial distance Li is equal to or greater than the bead radius, as measured in a radial direction from line XX′.

### Definitions

“About” means, unless otherwise specified, +/−10%.

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 0 to 45 degrees with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Block element” means a tread element defined by a circumferential groove or shoulder and a pair of laterally extending grooves.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction within + or −5 degrees.

“Cord” means one of the reinforcement strands, including fibers, which are used to reinforce the plies.

“Extensible” means a cord having a relative elongation at break of greater than 0.2% at 10% of the breaking load, when measured from a cord extracted from a cured tire. The tensile measurements for elongation at break (total elongation in %) are performed in accordance with ISO 6892-1B(2019) at preload no more than 25 mpa tested on a cable or cord when taken from a cured tire.

“Inner Liner” means the layer or layers of elastomer or other material that form the inside surface of a tubeless tire and that contain the inflating fluid within the tire.

“Inserts” means the reinforcement typically used to reinforce the side edges of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

“Radial Ply Tire” means a belted or circumferentially-restricted pneumatic tire in which the ply cords which extend from bead to bead are laid at cord angles between 65° and 90° with respect to the equatorial plane of the tire.

“Side edge” means a portion of a tire between the tread and the bead.

“Sipe” means small slots or elongated void areas typically formed by thin steel blades, and which tend to remain closed, and function to increase traction.

“Laminate structure” means an unvulcanized structure made of one or more layers of tire or elastomer components such as the innerliner, side edges, and optional ply layer.

### BRIEF DESCRIPTION OF THE DRAWINGS

The invention will be described by way of example and with reference to the accompanying drawings in which:

FIG. 1 is a cross-sectional view of one half of a radial ply tire;

FIG. 2 is a close-up view of the lower sidewall and bead portion of the tire of FIG. 1; and

FIG. 3 is a close-up view of the bead area of the tire of FIG. 1.

### DETAILED DESCRIPTION OF THE INVENTION

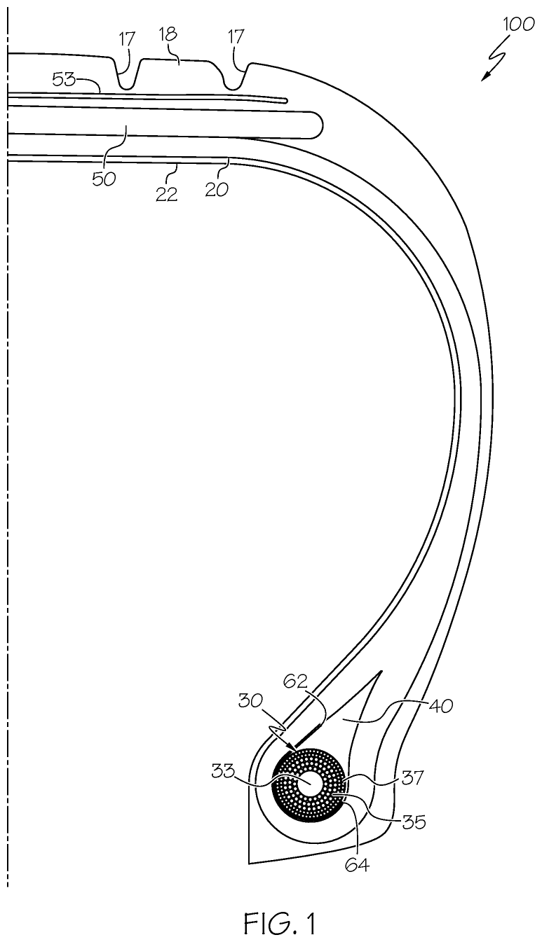

With reference to FIG. 1, a cross-sectional view of one half of a radial ply tire 100 is shown. The tire 100, as illustrated, is a construction for use as an aircraft tire. The tire 100 by way of example is a radial aircraft tire exposed to high internal pressures and tremendous loads. Other such tires such as earthmover, commercial truck and farm tires are also ideally suited for using the bead core of the present invention.

The tire 100 is a radial ply tire of the tubeless type construction. The tire 100 has an air imperious inner liner 22 which contains fluid or air under pressure. Radially outward of the inner liner 22 are one or more radial plies 20. Each ply 20 extends from an annular tensile member commonly referred to as a bead core 30. As shown the plies 20 wrap about the bead core 30 either turning axially out and up forming a ply turnup or alternately turning axially in and under the bead core 30. Radially above the bead core 30 is a rubber apex 40.

Radially outward of the carcass plies 20 is a belt package 50 comprising a plurality of belt reinforcing layers, each layer is reinforced with parallel reinforcement cords. A top belt layer 53 is shown radially outward of the belt layers 50. Above the top belt layer 53 is a tread 18 as shown, the tread 18 has a plurality of optional circumferentially continuous grooves 17. The tire structure 100 as mentioned is an example of one type of tire structures that can utilize the bead core 30 of the present invention. Although the tire 100 as shown is an aircraft tire structure, the invention is usable in any highly loaded heavy-duty tire structure.

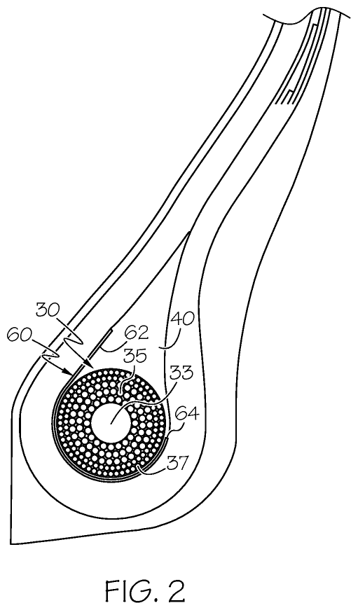

With reference to FIG. 2, the bead core 30 of the present invention is shown. As illustrated the central core 33 is shown as a single wire or rod wound at 360 degree, wherein the ends of the wire are preferably welded to form one continuous hoop or central core 33. The central core 33 preferably has a diameter in the range of 3 mm to 15 mm, and more preferably in the range of 5 to 15 mm. The central core 33 is preferably made of an alloy of aluminum, or other lightweight metal alloy such as magnesium, titanium, or any metal alloy having a weight less than steel. The central core may be solid metal such as shown, or may be an annulus formed of metal such as aluminum, or formed of plastic, aramid, carbon fiber or nylon. The center of the annulus (tube) may be filled with air or a filler such as aramid, carbon fiber, or plastic resin. The central core may also be formed of solid aramid or a aramid annulus (pipe), solid carbon fiber, or a carbon fiber annulus (pipe) or a metal annulus (pipe) filled with either plastic resin or air.

As further illustrated, the central core 33 is wrapped by an annular row of inner sheath layers 35, preferably at least two rows of annular inner sheath layers 35, wherein each inner sheath layer has a plurality of wires arranged in a circle with a diameter B. Preferably, the diameter of the wires of the inner sheath layer 35 are the same, and range in size from 1.5 mm to about 3 mm, and more preferably, in the range of 1.8 mm to about 2.5 mm. Preferably, there are three to four rows of annular sheath layers 35. The wires 36 of the sheath layers are steel that are helically or spirally wound about the central core 33.

The bead core 30 further includes one or more annular rows of outer sheath layers 37. The wires in the outer annular row have a smaller diameter than the diameter of the wires in the inner annular sheath layers. Preferably, the diameter C of the wires of the outer sheath layer 37 are the same, and range in size from 1.5 mm to about 2.5 mm, and more preferably, in the range of 1.mm to about 2.mm.

The entire bead is coated in an adhesive rubber layer and then a textile ply cord is helically wrapped around the bead cord.

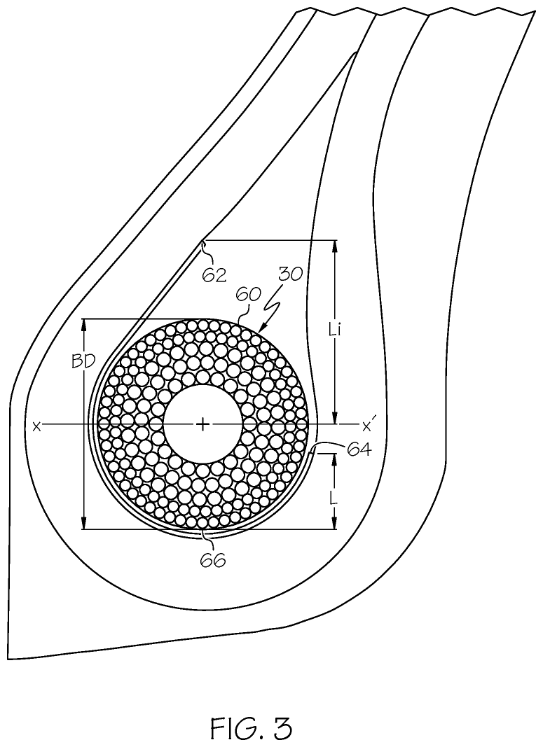

Wrapped around the entire bead core is a flipper 60, having an axially inner leg 62 and an axially outer leg 64. The flipper 60 is formed from a reinforced fabric wrapped about the bead core such as nylon or polyester. The reinforcement cords of the flipper material may preferably have a 840 d/2, or a 1260 d/2, or a 1260 d/3, a 1890 d/2 and a 1890 d/3 nylon cord construction. Preferably, the flipper material is nylon 6/6. As shown in FIG. 3, the axially inner leg 62 of the flipper 60 is located at a radial distance Li from the reference line XX′, wherein the line XX′ extends through the geometric center of the bead core. The radial bead height Li is preferably greater than the bead radius, as measured in a radial direction from line XX′. The axially outer end 64 of the flipper 60 is located at a radial distance L from the bottom 66 of the bead core. The axially outer end 64 may terminate in the range: from radially outward of the bottom of the bead core 66 to radially outward but radially inward of the bead core center, wherein the radial distance L is measured from the bottom 66 of the bead core.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic radial tire having a bead portion provided therein with a bead core, wherein the bead core is wrapped with a flipper, wherein the flipper is formed of a reinforced material, wherein the flipper has an axially inner leg that extends radially outward to a radial distance Li from the reference line XX′, wherein the line XX′ extends through the geometric center of the bead core, wherein the radial distance Li is equal to or greater than the bead radius, as measured in a radial direction from line XX′.

2. The pneumatic tire of claim 1 wherein the axially inner leg has a radial height less than the bead core diameter.

3. The pneumatic tire of claim 1 wherein the flipper has an axially outer end that is located radially inward of the bead core center.

4. The pneumatic radial tire of claim 1 wherein the axially outer end of the flipper is located radially outward of the radially innermost point of the bead core.

5. The pneumatic radial tire of claim 1 wherein the bead core has a central core having a first layer of a plurality of sheath wires surrounding the bead central core, and a second layer formed of a plurality of sheath wires surrounding the first layer, wherein the second layer of shear wires has a diameter less than the sheath wires of the first layer.

6. The pneumatic radial tire of claim 1 wherein the diameter of the sheath wires of the first layer is in the range of 1.5 mm to 3.0 mm.

7. The pneumatic radial tire of claim 1 wherein the diameter of the sheath wires of the second layer is in the range of 1 mm to 2 mm.

8. The pneumatic radial tire of claim 1 wherein the cross-sectional shape of the bead central core is an annulus.

9. The pneumatic radial tire of claim 7 wherein the annular has a hollow inner portion.

10. The pneumatic radial tire of claim 1 wherein the material of the bead central core is selected from the group of titanium, aluminum, magnesium, or other metal alloy.

11. The pneumatic radial tire of claim 1 wherein the material of the bead central core is selected from the group of aramid, carbon fiber, plastic or other nonmetal material.

12. The pneumatic radial tire of claim 1 wherein there are a total of three annular rows of sheath wires in the first layer.

13. The pneumatic radial tire of claim 1 wherein there are two rows of sheath wires in the outer layer.

14. A pneumatic radial tire having a bead portion provided therein with a bead core, wherein the bead core is wrapped with a flipper, wherein the flipper is formed of a reinforced material, wherein the flipper has an axially inner end and an axially outer end that is located radially inward of the bead core center.

15. The pneumatic radial tire of claim 14 wherein the flipper has an axially inner leg that extends radially outward to a radial distance Li from the reference line XX′, wherein the line XX′ extends through the geometric center of the bead core, wherein the radial distance Li is equal to or greater than the bead radius, as measured in a radial direction from line XX′.
